(19) United States
(12) Patent Application Publication
(10) Pub. No.: US 2004/0131055 A1
(43) Pub. Date: Jul. 8, 2004

(54) Memory management free pointer pool

(76) Inventors: Juan-Carlos Calderon, Fremont, CA (US); Jean-Michel Caia, San Francisco, CA (US); Jing Ling, Fremont, CA (US); Vivek Joshi, Sunnyvale, CA (US); Anguo T. Huang, Mountain View, CA (US)

Correspondence Address: SMYRSKI & LIVESAY, LLP, 3310 AIRPORT AVENUE, SW, SANTA MONICA, CA, 90405, US

(21) Appl. No.: 10/337,908

(22) Filed: Jan. 6, 2003

(51) Int. Cl. H04Q 11/00; G06F 12/00

(52) U.S. Cl. 370/381; 711/105; 711/173

(57) ABSTRACT

A method and apparatus for managing multiple pointers is provided. Each pointer may be associated with a partition in a partitioned memory, such as DDR SDRAM used in a high speed networking environment. The system and method include a free pointer pool FIFO, wherein a predetermined quantity of pointers is allocated to the free pointer pool FIFO. The system selects one pointer from the free pointer pool FIFO when writing data to one partition in the partitioned memory, and provides one pointer to the free pointer pool FIFO when reading data from one partition in the partitioned memory. The system and method enable self balancing using the free pointer pool FIFO and decreases the number of memory accesses required. The system can be located on chip.

### BACKGROUND OF THE INVENTION

1. Field of the Invention

The present invention relates generally to the field of high speed data transfer, and more specifically to managing data memory, such as synchronous dynamic random access memory (SDRAM), divided into relatively small linked partitions.

2. Description of the Related Art

Data communication networks receive and transmit ever increasing amounts of data. Data is transmitted from an originator or requester through a network to a destination, such as a router, switching platform, other network, or application. Along this path may be multiple transfer points, such as hardware routers, that receive data typically in the form of packets or data frames. At each transfer point data must be routed to the next point in the network in a rapid and efficient manner.

High speed networking systems typically employ a memory, connected via a memory data bus or interface to other hardware networking components. The memory holds data in a set of partitions, and positions and retrieves this data using a series of pointers to indicate the beginning of each partition. High speed networking applications are currently in the range of ten times faster than previous implementations, but memory technologies have not provided increased efficiency in the presence of larger and larger memories.

Double Data Rate (DDR) SDRAM data memory is one example of a large memory having a large number of partitions and a significant number of pointers. The number of pointers in newer systems is too large to store on the DDR SDRAM chip, so available pointers are typically stored off chip. Pointers are managed by a communications memory manager, which obtains a pointer every time a new cell or packet fragment is established, and returns a pointer every time a partition is dequeued. Storage of pointers off chip requires that the communications memory manager fetch the pointers and replace the pointers to the off chip location, which tends to adversely effect speed, throughput and overall memory efficiency. Further, SDRAM memory typically exhibits significant latency. A DDR SDRAM pointer management design that minimizes the adverse effects associated with off chip pointer storage would improve over previously available implementations.

### DESCRIPTION OF THE DRAWINGS

The present invention is illustrated by way of example, and not by way of limitation, in the figures of the accompanying drawings in which:

FIG. 1A is a conceptual illustration of a packet switching system;

FIG. 1B is a block diagram illustrating an example of a prior art partitioning of a physical memory;

FIG. 2A is a block diagram illustrating an example of a memory;

FIG. 2B presents a block diagram illustrating another example of a memory;

FIG. 2C is a block diagram illustrating an example of a partition;

FIG. 2D illustrates an example of a FIFO buffer including more than one partition;

FIG. 3 shows the construction of a prior art memory manager;

FIG. 4 illustrates a memory management configuration employing an on chip free pointer pool FIFO;

FIG. 5 shows partitioning of a memory such as DDR SDRAM having a free pointer pool included in certain partitions;

FIG. 6A shows a 64 bit wide arrangement of 20 pointers in memory;

FIG. 6B is a 128 bit wide arrangement of 20 pointers in memory; and

FIG. 7 illustrates a 64 byte, eight word partition.

### DETAILED DESCRIPTION OF THE INVENTION

Digital communication systems typically employ packet-switching systems that transmit blocks of data called packets. Typically, data to be sent in a message is longer than the size of a packet and must be broken into a series of packets. Each packet consists of a portion of the data being transmitted and control information in a header used to route the packet through the network to its destination.

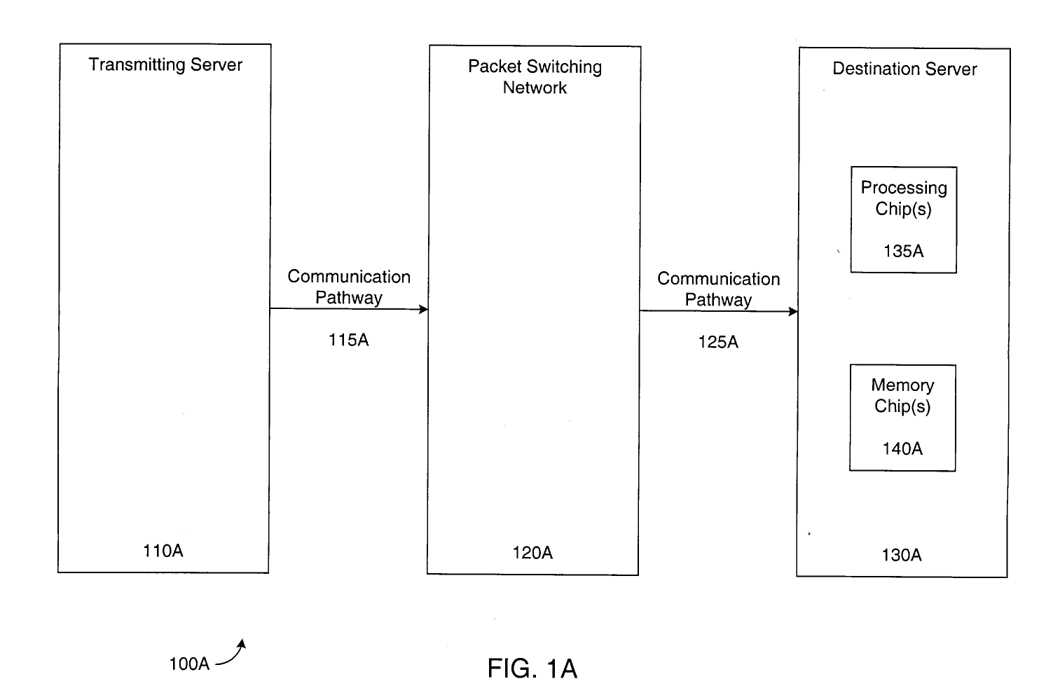

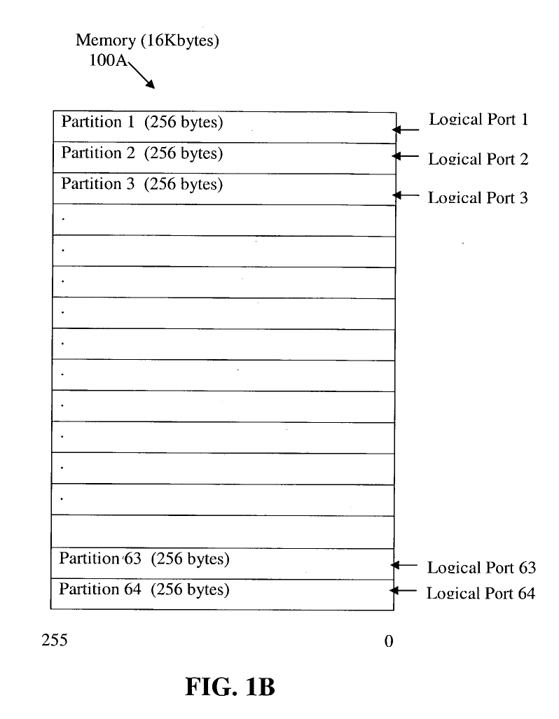

A typical packet switching system 100A is shown in FIG. 1A. In the system 10A, a transmitting server 110A is connected through a communication pathway 115A to a packet switching network 120A. Packet switching network 120A is connected through a communication pathway 125A to a destination server 130A. The transmitting server 110A sends a message as a series of packets to the destination server 130A through the packet switching network 120A. In the packet switching network 120A, packets typically pass through a series of servers. As each packet arrives at a server, the server stores the packet briefly before transmitting the packet to the next server. The packets proceed through the network until they arrive at the destination server 130A. The destination server 130A contains memory partitions on one or more processing chips 135 and on one or more memory chips 140A. The memory chips 140A may use various memory technologies, including SDRAM.

For illustrative purposes, a particular implementation of a packet switching system is described. For ease of description, a particular implementation in which a message may be any length, a packet may vary from 1 to 64K bytes, and the memory partition size is 64 bytes is used. Many implementations may employ variable length packets having maximum packet sizes and memory partition sizes larger than 64 bytes. For example, maximum packet sizes of two kilobytes or four kilobytes may be used.

Packet switching systems may manage data traffic by maintaining a linked list of the packets. A linked list may include a series of packets stored in partitions in external memory, such that the data stored in one partition points to the partition that stores the next data in the linked list. As the data are stored in external memory, memory space may be wasted by using only a portion of a memory partition.

The present design is directed toward efficient memory operation within such a packet switching system, either internal or external, and may also apply to computer, networking, or other hardware memories including, but not limited to, SDRAM memories. One typical hardware application employing SDRAM is a network switch that temporarily stores packet data. Network switches are frequently used on Ethernet networks to connect multiple sub-networks. A switch receives packet data from one sub-network and passes that packet data onto another sub-network. Upon receiving a packet, a network switch may divide the packet data into multiple sub-packets or cells. Each of the cells includes additional header data. As is well known in the art, Ethernet packet data has a maximum size of approximately 1.5 Kbytes. With the additional header data associated with the cells, a packet of data has a maximum size in the range of under 2 Kbytes.

After dividing the packet data into cells, the network switch may temporarily allocate a memory buffer in the SDRAM to store the packet before retransmission. The address and packet data are translated to the SDRAM, which may operate at a different clock rate than other hardware within the switch. The packet data is then stored in the memory buffer. For retransmission, the switch again accesses the SDRAM to retrieve the packet data. Both the storage and retrieval of data from the SDRAM introduce access delays.

In the present design, the memory employed may be partitioned into a variety of memory partitions for ease of storage and retrieval of the packet data.

Memory Partitioning

FIG. 1B is a block diagram illustrating an example of physical memory partitioning. Typically, memory 100 is divided into equal fixed-size partitions with each of the partitions used as a FIFO buffer and assigned to a flow. Each flow may be associated with a device, such as an asynchronous transfer mode (ATM) device. The size of the memory 100 may be 1 Gbyte, for example, and the memory 100 may be divided into 256K partitions. Each of the 256K partitions may be statically assigned to a flow (e.g., the partition 1 is assigned to the flow 1, etc.) such that every flow is associated with at most one partition. No free partition exists. In this example, each partition is 4 Kbytes long. This partitioning technique is referred to as complete partitioning.

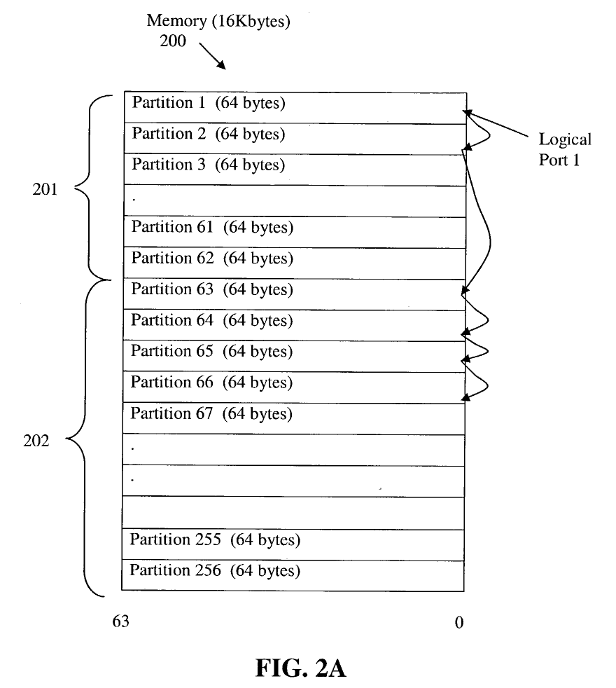

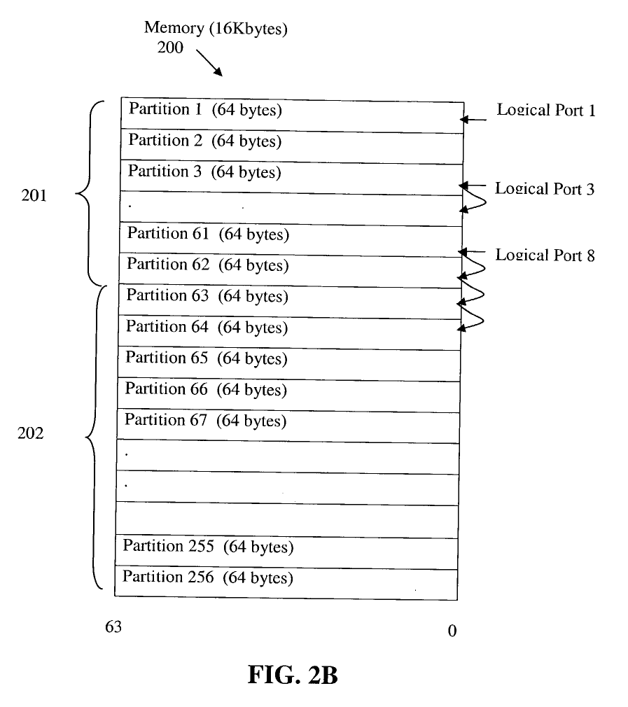

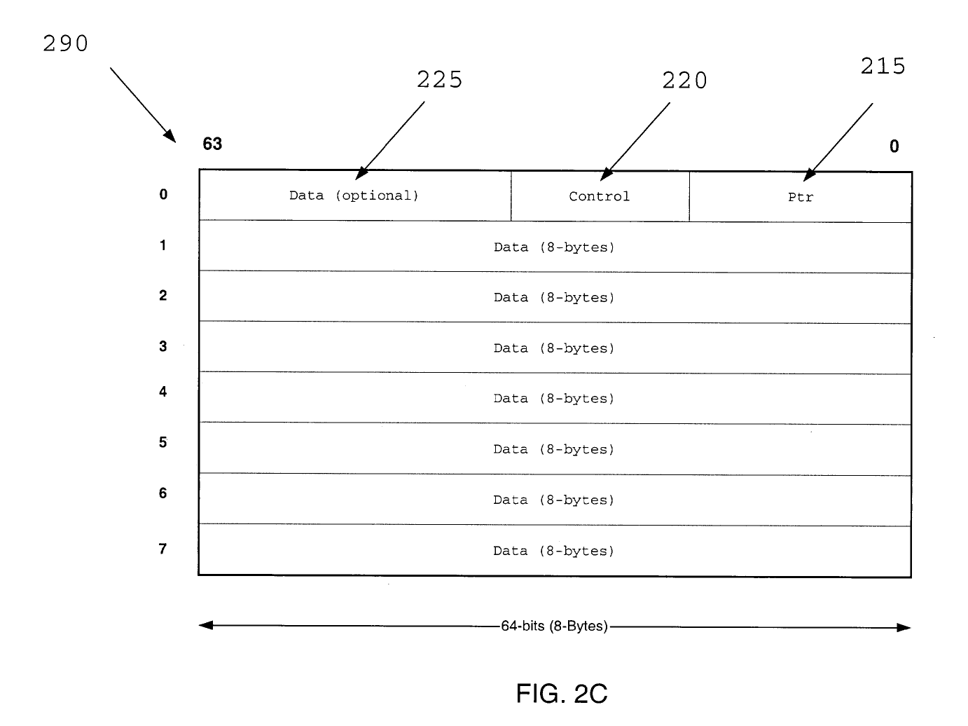

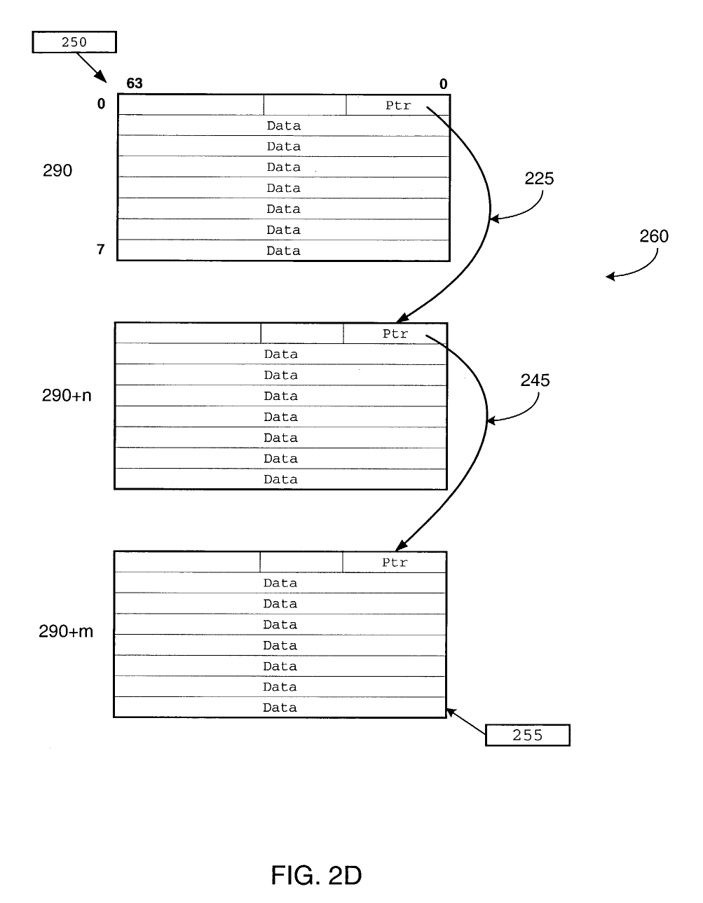

FIG. 2 is a block diagram illustrating another example of a memory and its partitions, where memory 200 may be partitioned into multiple partitions. The number of partitions may be at least equal to the number of supported flows, and the partitions may be of the same size. For example, the size of the memory 200 may be 1 Gb, and the memory 200 may be partitioned into 16M (16×1024×1024) equally sized partitions, even though there may only be 256K flows.

In this design, partitions may be grouped into two virtual or logical groups, a dedicated group and a shared group. For example, referring to the example illustrated in FIG. 2A, there may be 4M partitions in the dedicated group 201 and 12M partitions in the shared group 202. The grouping of partitions described here relates to the number of partitions in each group. The partitions 1-16M in the current example may not all be at contiguous addresses.

Each flow may be associated with a FIFO buffer. Each FIFO buffer may span multiple partitions assigned to that flow. The multiple partitions may or may not be contiguous. The size of the FIFO buffer may be dynamic. For example, the size of a FIFO buffer may increase when more partitions are assigned to the flow. Similarly, the size of the FIFO buffer may decrease when the flow no longer needs the assigned partitions. The function of the FIFO buffer is to transfer data to the partitioned memory in a first in, first out manner.

FIG. 2B is a block diagram illustrating another example of a memory and its partitions. In this example, there are three flows 1, 3 and 8, each assigned at least one partition from the dedicated group 201. These may be considered active ports because each has assigned partitions, and unread data may exist in these partitions. One or more inactive ports may exist, and no partitions are typically assigned to inactive ports.

FIG. 2C is a block diagram illustrating an example of a partition. A partition may include a data section to store user data and a control section to store control information. For example, partition 290 may include a data section 225 that includes user data. Unit zero (0) of the partition 290 may also include a control section 220. The control information about the data may include, for example, start of packet, end of packet, error condition, etc.

Each partition may include a pointer that points to a next partition (referred to as a next partition pointer) in the FIFO buffer. For example, the first data unit 225 of the partition 290 may include a next partition pointer. The next partition pointer may be used to link one partition to another partition when the FIFO buffer includes more than one partition. When a partition is a last or only partition in the FIFO buffer, the next partition pointer of that partition may have a null value. For one embodiment, the next partition pointer may be stored in a separate memory leaving more memory space in the partition 290 for storing data.

Unit 0 is the only unit in the foregoing example configuration containing control information or a pointer. As illustrated in FIG. 2C, Units 1 through 7 are dedicated to 8 bytes of data each.

FIG. 2D is a block diagram illustrating an example of a FIFO buffer that includes more than one partition. FIFO buffer 260 in this example includes three partitions, partition 290, partition 290+n, and partition 290+m. These partitions may or may not be contiguous and may be in any physical order. The partition 290 is linked to the partition 290+n using the next partition pointer 225. The partition 290+n is linked to the partition 290+m using the next partition pointer 245. The next partition pointer of the partition 290+m may have a null value to indicate that there is no other partition in the FIFO buffer 260.

The FIFO buffer 260 may be associated with a head pointer 250 and a tail pointer 255. The head pointer 250 may point to the beginning of the data, which in this example may be in the first partition 290 of the FIFO buffer 260. The tail pointer 255 may point to the end of the data, which in this example may be in the last partition 290+m of the FIFO buffer 260. As the data is read from the FIFO buffer 260, the head pointer 250 may be updated accordingly. When the data is completely read from the partition 290, the head pointer 250 may then be updated to point to the beginning of the data in the partition 290+n. This may be done using the next partition pointer 225 to locate the partition 290+n. The partition 290 may then be returned.

From FIG. 2B, partitions in the dedicated group 201 and/or in the shared group 202 may not have been assigned to any flow. These partitions are considered free or available partitions and may logically be grouped together in a free pool. For example, when a flow returns a partition to either the shared group 202 or the dedicated group 201, it may be logically be viewed as being returned to the free pool.

Memory Management

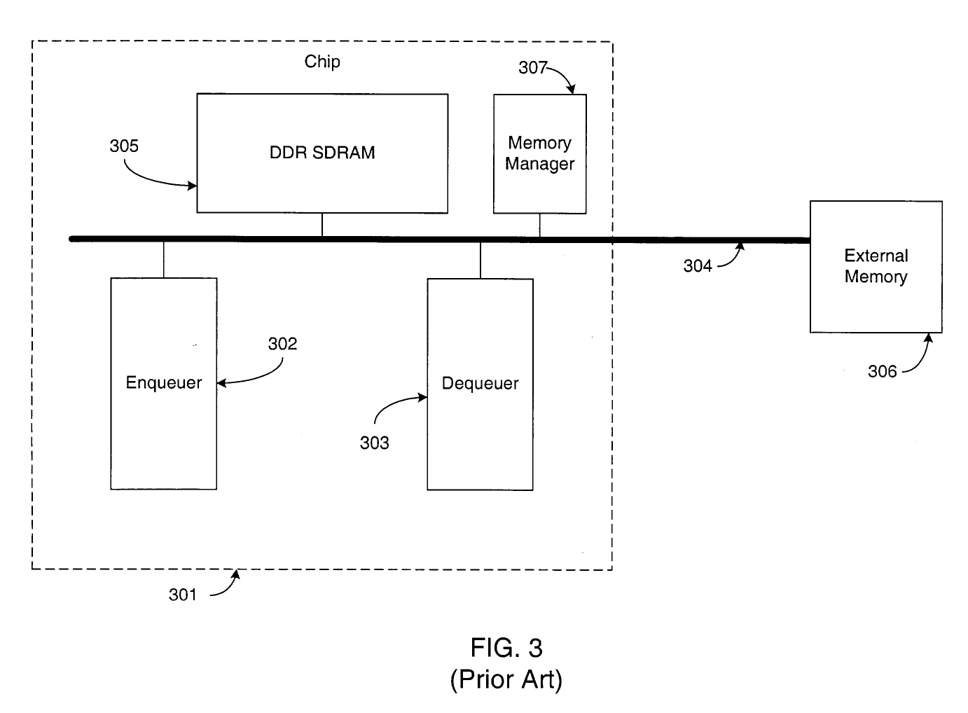

One example of a previous memory management system used to manage memory, either partitioned or not partitioned, is illustrated in FIG. 3. For the system shown in FIG. 3, memory management entails obtaining a pointer to a free partition every time a new cell or fragment of a packet is enqueued to a data buffer. The memory manager also returns a pointer to memory every time a partition is dequeued. As shown in FIG. 3, chip 301 includes enqueuer 302, dequeuer 303, DDR SDRAM interface 304, and DDR SDRAM 305. External memory 306 resides off chip and holds free pointers, as the size of the DDR SDRAM 305 dictates that pointers cannot be held within DDR SDRAM 305. The memory manager 307, which has typically been on chip but may be off chip, receives an indication that a new cell has been received, obtains a pointer from external memory 306, and provides the pointer to the enqueuer 302 which enqueues the pointer and new cell and places them in DDR SDRAM 305 in one partition. When dequeued, the dequeuer 303 obtains the pointer and the cell in the partition, provides the pointer to the external memory for recycling, and passes the cell for processing, which may include assembly into a packet. Thus external memory is accessed every time that a cell is dequeued or enqueued, and the required reading and writing of pointers significantly decreases memory access efficiency because of the requisite access time to the external memory 305.

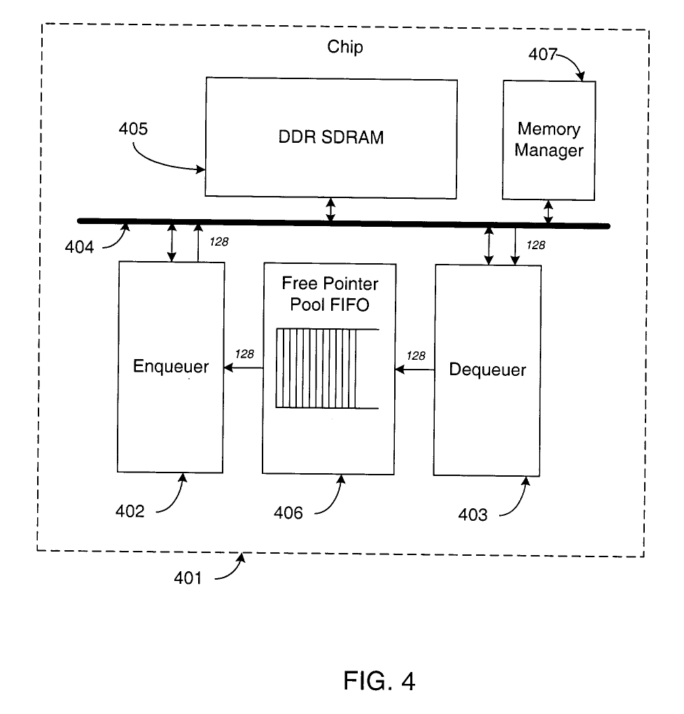

FIG. 4 illustrates an on-chip implementation enabling improved access times to free pointers. FIG. 4 presents a chip 401 having an enqueuer 402, a dequeuer 403, a DDR SDRAM interface 404, and a DDR SDRAM 405. The chip 401 further includes a free pointer pool FIFO 406 located between the dequeuer 403 and the enqueuer 404.

The memory manager 407 receives an indication that a new cell has been received, obtains a pointer from the free pointer pool FIFO 406, and provides the pointer to the enqueuer 402 which enqueues the pointer and new cell and places them in DDR SDRAM 405 in one partition. When dequeued, the dequeuer 403 obtains the pointer and the cell in the partition within the DDR SDRAM, provides the pointer to the free pointer pool FIFO 406, and passes the cell for processing, which may include assembly into a packet. Thus the free pointer pool FIFO 406 acts as a balancing mechanism that operates to continuously recycle unused pointers located on the DDR SDRAM 405. A certain quantity of unused pointers is located in the DDR SDRAM 405, and those pointers may be freely transferred to and from free pointer pool FIFO 406.

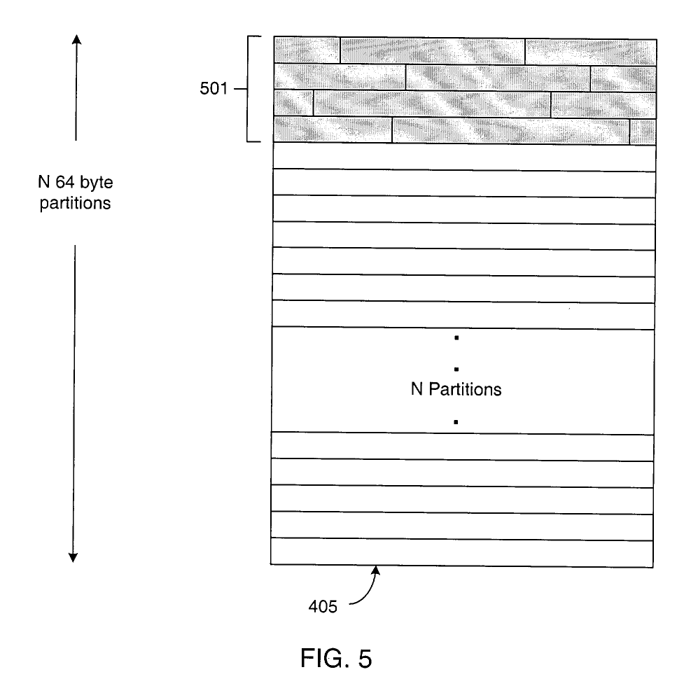

FIG. 5 illustrates the composition of a sample DDR SDRAM 405 having N partitions, of any size but for purposes of this example having a size of 64 bytes. The free pointer pool 501 within the DDR SDRAM 405 occupies a certain subsection of the DDR SDRAM 405, and various sizes may be employed depending on circumstances, such as the pointer size and DDR SDRAM or other memory size, such as 5 per cent of the entire memory. In this example, the free pointer pool 501 occupies N/20 partitions and may store as many as N pointers. Pointer size in this example is 25 bits. Thus as shown in FIG. 3, the DDR SDRAM 405 is divided into multiple partitions of 64 bytes each in this example. A subsection of the DDR SDRAM 405 includes the free pointer pool 501, such as 5 per cent of the DDR SDRAM 405, and the other 95 per cent is used to store data partitions used to build data buffers. The DDR SDRAM 405 memory segment including the free pointer pool 501 is also divided into partitions, such as 64 byte partitions, and in this example can store twenty 25 bit pointers to free data partitions. The 64 byte partitions can be accessed as a circular buffer.

As may be appreciated by one skilled in the art, virtually all variables or elements described in connection with this example may be altered, namely increased in size or quantity or decreased in size or quantity, including but not limited to pointer size, partition number and size, free pointer pool size, and percentage of memory taken up by the free pointer pool. The example is meant by way of illustration and not limitation on the concepts disclosed herein.

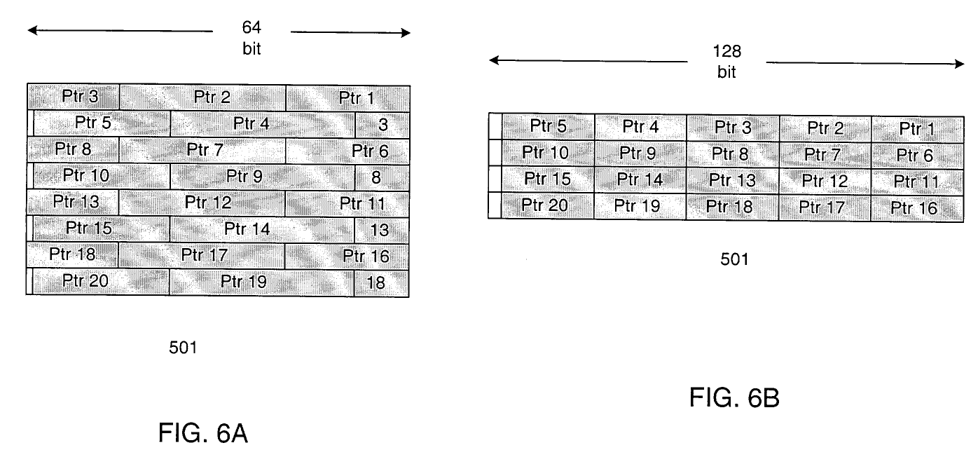

In one particular implementation in accordance with the foregoing example, 20 free partition pointers may be stored in the 64 byte partitions occupying 5 per cent of the DDR SDRAM 405, as shown in FIG. 6A. If 128 bits memory data bus width is employed, the pointers may be stored as shown in FIG. 6B. The memory manager may communicate with the DDR SDRAM using a 128 bit bus interface as DDR SDRAM interface 404.

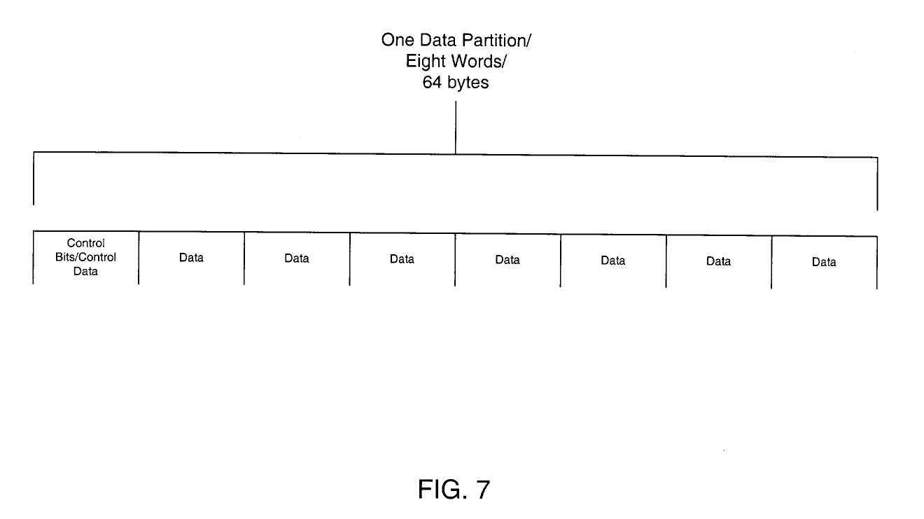

The 64 byte data partitions, such as each of the individual partitions illustrated in FIGS. 6A and 6B, may be organized as eight words having eight bytes each. As shown in FIG. 7, the first word of the data partition includes control information, including a 25 bit pointer to the next partition, and certain control bits, including but not limited to start of packet, end of packet, and so forth. The remaining seven words or 56 bytes include data. Data cells or packets can be stored in different ways, typically depending on the type of data flow or the manner in which data is received. For a packet-to-packet flow, each partition may store the 56 bytes, a small segment of the data packet. The last partition may contain less than 56 bytes, and thus the number of bytes stored in the last partition of a packet is provided in the information stored in the control word. This control word makes up the first portion of the packet. In the event the memory operates with ATM (asynchronous transfer mode) cells, either in cell-to-cell, packet-to-cell, or cell-to-packet transfers from the input flows, each partition stores one complete ATM cell, typically having a 52 byte data width. In the event the packet is received as cells and converted to packets, one ATM cell received makes up the partition, and the cells can be assembled into packets.

Thus in this example, the on chip free pointer the on chip free pointer pool FIFO 406 is a 125 bit by 32 word memory. Each 125-bit entry in the free pointer pool FIFO 406 is a free pointer: the memory address of an available (or free) 64-byte partition located in the external SDRAM. The free pointer pool FIFO 406 may take various forms, but typically it must offer functionality of providing for reading and writing, thus including two ports, and must be able to store an adequate quantity of pointer partitions. One implementation of the free pointer pool FIFO 406 that can accommodate the foregoing example is a two port RAM having the ability to store four pointer partitions, or 80 pointers.

Operation of the on-chip free pointer pool FIFO 406 is as follows. When a cell or packet segment is enqueued, or stored in the DDR SDRAM 405, the enqueuer 402 may obtain a pointer, the pointer indicating an unused data partition within DDR SDRAM 405. The pointer is read from the on chip free pointer pool FIFO 406. When a cell or packet segment is dequeued, or read from the DDR SDRAM 405, the dequeuer 403 returns or stores the pointer associated with the dequeued partition for future reuse. The pointer is written to the on chip free pointer pool FIFO 406. When the contents of the on chip free pointer pool FIFO 406 is above a specified threshold, such as above 75 per cent of capacity, or above 60 pointers, the enqueuer 402 returns a block of 20 pointers, one 64 byte partition, to the free pointer pool in the DDR SDRAM 405. When the contents of the on chip free pointer pool FIFO 406 is below a specified threshold, such as below 25 per cent of capacity, or below 20 pointers, the dequeuer 403 reads a block of 20 pointers, one 64 byte partition, from the free pointer pool in the DDR SDRAM 405.

At initiation, a certain quantity of pointer may be loaded from DDR SDRAM 405 into the free pointer pool FIFO 406. For the aforementioned example, 40 pointers may be loaded into the free pointer pool. Data received is enqueued using the enqueuer 402, while data transmitted is dequeued from DDR SDRAM using the dequeuer 403. In a balanced environment, a similar number of pointers will be needed and returned over a given period of time, and thus the free pointer pool FIFO 406 may not require refilling or offloading to the DDR SDRAM 405. The free pointer pool FIFO 406 contents may exceed a threshold when certain WRITE cell cycles are not used to enqueue data partitions. One WRITE cell cycle is then used by the free pointer pool FIFO 406 to write a certain number of pointers to the DDR SDRAM 405 external free pointer pool. The free pointer pool FIFO 406 contents may fall below a threshold when certain READ cell cycles are not used to dequeue data partitions. One READ cell cycle is then used by the free pointer pool FIFO 406 to read a certain number of pointers from the DDR SDRAM 405 external free pointer pool. In this manner, access to DDR SDRAM for the purpose of reading or writing pointers operates at a very low rate, such as only once every 20 cycles or more.

The present design can be used by memory controllers supporting bank interleaving. For example, a memory controller implementing four bank interleaving may employ four on chip free pointer pool FIFOs 406. This design may be employed on memories other than DDR SDRAM, including but not limited to SDR SDRAM, and RDRAM, or generally any memory having the ability to change partition size and FIFO size.

The present system may be implemented using alternate hardware, software, and/or firmware having the capability to function as described herein. One implementation is a processor having available queueing, parsing, and assembly capability, data memory, and possibly on chip storage, but other hardware, software, and/or firmware may be employed.

It will be appreciated to those of skill in the art that the present design may be applied to other memory management systems that perform enqueueing and/or dequeueing, and is not restricted to the memory or memory management structures and processes described herein. Further, while specific hardware elements, memory types, partitioning, control fields, flows, and related elements have been discussed herein, it is to be understood that more or less of each may be employed while still within the scope of the present invention. Accordingly, any and all modifications, variations, or equivalent arrangements which may occur to those skilled in the art, should be considered to be within the scope of the present invention as defined in the appended claims.

What is claimed is:

1. A method for managing a plurality of pointers, each pointer able to be associated with a partition in a partitioned memory, comprising:
establishing a free pointer pool first in first out buffer;
allocating a predetermined quantity of pointers to the free pointer pool first in first out buffer;
selecting one pointer from said free pointer pool first in first out buffer when writing data to one partition in the partitioned memory; and
providing one pointer to said free pointer pool first in first out buffer when reading data from one partition in the partitioned memory.

2. The method of claim 1, wherein said partitioned memory and said free pointer pool first in first out buffer are located on a single chip.

3. The method of claim 1, wherein said allocating comprises transferring said predetermined quantity of pointers from partitioned memory.

4. The method of claim 3, further comprising transferring a further predetermined quantity of pointers from the partitioned memory to the free pointer pool first in first out buffer when a quantity of pointers within the free pointer pool first in first out buffer falls below a first threshold.

5. The method of claim 4, further comprising transferring a still further predetermined quantity of pointers from the free pointer pool first in first out buffer to the partitioned memory when the quantity of pointers within the free pointer pool first in first out buffer rises above a second threshold.

6. The method of claim 1, further comprising periodically rebalancing a quantity of pointers maintained within the free pointer pool first in first out buffer by transferring pointers between the free pointer pool first in first out buffer and the partitioned memory.

7. The method of claim 1, further comprising setting up a pointer pool within the partitioned memory prior to said establishing, said pointer pool comprising at least one pointer.

8. A system for managing partitioned memory using at least one pointer, each pointer associated with a partition in partitioned memory, comprising:
a free pointer pool first in first out buffer configured to maintain a plurality of pointers;
an enqueuer connected to said free pointer pool first in first out buffer, said enqueuer configured to retrieve data from one partition in partitioned memory and its associated first pointer, transmit said data, and return the associated first pointer to the free pointer pool first in first out buffer; and
a dequeuer connected to said free pointer pool first in first out buffer, said dequeuer configured to receive data and place data in one partition in partitioned memory together with an associated second pointer, said second associated pointer being retrieved from the free pointer pool first in first out buffer.

9. The system of claim 8, wherein said partitioned memory initially comprises at least one pointer.

10. The system of claim 8, wherein said partitioned memory is configured to transfer a first predetermined quantity of pointers to the free pointer pool first in first out buffer when the plurality of pointers in the free pointer pool first in first out buffer falls below a first threshold.

11. The system of claim 10, wherein said free pointer pool first in first out buffer is configured to transfer a second predetermined quantity of pointers to the partitioned memory when the plurality of pointers in the free pointer pool first in first out buffer rises above a second threshold.

12. The system of claim 8, wherein said free pointer pool first in first out buffer, said enqueuer, and said dequeuer reside on a single chip.

13. The system of claim 8, wherein said free pointer pool first in first out memory buffer and said partitioned memory periodically rebalance a quantity of pointers maintained within the free pointer pool first in first out buffer by transferring pointers between the free pointer pool first in first out buffer and the partitioned memory.

14. A method for managing partitioned memory using at least one pointer, each pointer associated with a partition in partitioned memory, comprising:
tranferring a plurality of pointers from partitioned memory to a free pointer pool FIFO;
receiving a cell;
dequeueing said cell;
retrieving a pointer from the free pointer pool FIFO; and
storing at least a portion of the cell to one partition in partitioned memory and associating the pointer with the cell.

15. The method of claim 14, further comprising:
obtaining at least a portion of one cell and a pointer associated with the one cell from the partitioned memory;
enqueuing the one cell for transmission; and
transferring the pointer associated with the one cell to the free pointer pool FIFO.

16. The method of claim 14, wherein the free pointer pool FIFO and the partitioned memory are located on a single chip.

17. The method of claim 14, further comprising transferring a further predetermined quantity of pointers from the partitioned memory to the free pointer pool FIFO when a quantity of pointers within the free pointer pool FIFO falls below a first threshold.

18. The method of claim 15, further comprising transferring a still further predetermined quantity of pointers from the free pointer pool FIFO to the partitioned memory when the quantity of pointers within the free pointer pool FIFO rises above a second threshold.

19. The method of claim 14, further comprising periodically rebalancing a quantity of pointers maintained within the free pointer pool FIFO by transferring pointers between the free pointer pool FIFO and the partitioned memory.
